(19) United States
(12) Patent Application Publication
(10) Pub. No.: US 2009/0200853 A1
(43) Pub. Date: Aug. 13, 2009

(54) Mid-sized side dump trailer

(76) Inventors: Bobby Rogers, North Sioux City, SD (US); Ralph Rogers, Dakota Dunes, SD (US)

Correspondence Address: THOMTE LAW OFFICE, L.L.C., 2120 S. 72ND STREET, SUITE 1111, OMAHA, NE, 68124, US

(21) Appl. No.: 12/218,944

(22) Filed: Jul. 18, 2008

Related U.S. Application Data
(63) Continuation-in-part of application No. 12/069,131, filed on Feb. 7, 2008.

(51) Int. Cl. B60D 1/48; B60P 1/28

(52) U.S. Cl. 298/22 R; 298/18

(57) ABSTRACT

A mid-sized side dump trailer comprising a wheeled frame having a pair of wheels supporting the rearward end thereof and a steerable front wheel assembly of the forward end thereof with a forwardly extending tongue extending from the front wheel assembly for connection to a small vehicle such as a utility terrain vehicle, an all terrain vehicle or a small tractor. The small side dump body may be pivoted to either the first side of the trailer or to the second side of the trailer.

### CROSS REFERENCE TO RELATED APPLICATION

This is a continuation-in-part application of the application Ser. No. 12/069,131 filed Feb. 7, 2008 entitled MINI-SIZED SIDE DUMP TRAILER.

### BACKGROUND OF THE INVENTION

1. Field of the Invention

This invention relates to a side dump trailer and more particularly to a mid-sized side dump trailer. Even more particularly, this invention relates to a side dump trailer having a hitch mounting structure at the forward end thereof to which either a ball hitch assembly or a gooseneck hitch assembly may be selectively secured thereto. The trailer also has a hitch at its rearward end to enable another trailer to be towed therebehind.

2. Description of the Related Art

Non-limiting and non-exhaustive embodiments of the present invention are described with reference to the following figures, wherein like reference numerals refer to like parts throughout the various views unless otherwise specified.

Side dump bodies for use on trucks and trailers have become extremely popular in recent years since the introduction of the side dump trailer of co-applicant, Ralph R. Rogers, which is disclosed in U.S. Pat. No. 5,480,214 and many other patents granted to co-applicant. The side dump trailers of the prior art are extremely large and are not practical for smaller scale dumping needs. To applicants' knowledge, no one has previously provided a mini-sized side dump trailer, such as disclosed in the co-pending application identified above, and which has a capacity of approximately 34 cubic feet with an additional capacity if the material in the side dump body is heaped. Further, in most prior art side dump bodies, the power for pivoting the side dump bodies from a transport position to side dumping positions is derived from the prime mover itself. In other words, the trailer is not self-contained. Since the small side dump trailer of the co-pending application will be pulled by small vehicles such as a utility terrain vehicle, an all terrain vehicle, or a small tractor, some of those vehicles may not have either a hydraulic pump system or an electrical system needed to power the side dump body of the trailer.

Many of the problems of the prior art side dump trailers have been solved the mini-sized side dump trailer of the co-pending application. However, applicants have become aware of the need of a mid-sized side dump trailer having a capacity of approximately midway between the mini-sized trailer of the co-pending application and the full-sized prior art side dump trailers. Further, the side dump trailer of this invention includes interchangeable hitch structures at its forward which enables the trailer to be pulled by a vehicle having a ball hitch or having a gooseneck hitch structure.

### SUMMARY OF THE INVENTION

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

A mid-sized side dump trailer is disclosed which is adapted to be pulled by a small truck or tractor and which has a hitch at its rearward end which is adapted to enable another trailer to be pulled behind the side dump trailer of this invention.

The side dump trailer of this invention includes a wheeled frame having a forward end, a rearward end, a first side and a second side. A side dump body is pivotally mounted on the wheeled frame and has a forward end, a rearward end, a first side and a second side. The side dump body is pivotally movable on the wheeled frame from a transport position to at least one side dumping position, and preferably two side dumping positions.

The wheeled frame has a hitch mounting structure at its forward end to which a ball hitch assembly may be selectively secured thereto so as to extend forwardly from the forward end of the wheeled frame or to which a gooseneck hitch assembly may be selectively secured thereto so as to extend upwardly and forwardly from the forward end of the wheeled frame. The interchangeability of the ball hitch assembly and the gooseneck hitch assembly permits the trailer to be pulled by vehicles having different hitch structures at the rearward end thereof. The ball hitch assembly and the gooseneck hitch assembly are interchangeably bolted to the hitch mounting structure.

The side dump body is pivotally movable by at least one hydraulic cylinder, and preferably by two hydraulic cylinders. A rechargeable battery is mounted on the wheeled frame which drives an electrically operated hydraulic pump fluidly connected to the hydraulic cylinders. The hydraulic pump may also be driven by a small engine mounted on the wheeled frame. Further, the hydraulic pump may be electrically connected to the vehicle electrical system for powering the same. The hydraulic hoses for the hydraulic cylinders may also be connected to the vehicle hydraulic system if the vehicle is a tractor or the like.

It is therefore, the principal object of the invention to provide a mid-sized side dump trailer.

A further object of the invention is to provide a mid-sized side dump trailer which has a hitch mounting structure at the forward end thereof to which a ball hitch assembly or a gooseneck hitch assembly may be selectively secured.

A further object of the invention is to provide a mid-sized dump trailer which is ideally suited for landscapers, lawn services, farms and ranches, city maintenance, state and national parks, fairgrounds, sport complexes, golf courses, campgrounds, general contractors or the like.

A further object of the invention is to provide a mid-sized dump trailer which is much more maneuverable and easier to use than the conventional full-sized side dump trailers.

Still another object of the invention is to provide a mid-sized side dump trailer which has a self-contained power means for operating the movement of the side dump body.

Still another object of the invention is to provide a mid-sized side dump trailer which may be remotely radio controlled.

Still another object of the invention is to provide a mid-sized side dump trailer which is economical of manufacture, durable in use and refined in appearance.

These and other objects will be apparent to those skilled in the art.

### BRIEF DESCRIPTION OF THE DRAWINGS

FIG. 1 is a front perspective view of the trailer of this invention with a gooseneck hitch assembly at its forward end;

FIG. 2 is a side view of the trailer of FIG. 1 with the broken lines indicating a ball hitch assembly being mounted at the forward end of the trailer rather than the gooseneck hitch assembly;

FIG. 3 is a partial front perspective view of the trailer prior to entry of the hitch assemblies being secured thereto;

FIG. 4 is a front perspective view of the gooseneck hitch assembly;

FIG. 5 is a front perspective view of the ball hitch assembly;

FIG. 6 is a rear perspective view of the trailer;

FIG. 7 is a rear perspective view of the hitch structure which is secured to the rear of the trailer;

FIG. 8 is a front perspective view of the hitch structure of FIG. 7;

FIG. 9 is a schematic of the means for dump trailer with respect to the wheeled frame; and

FIG. 10 is a partial top view of the means for operating the hydraulic cylinder.

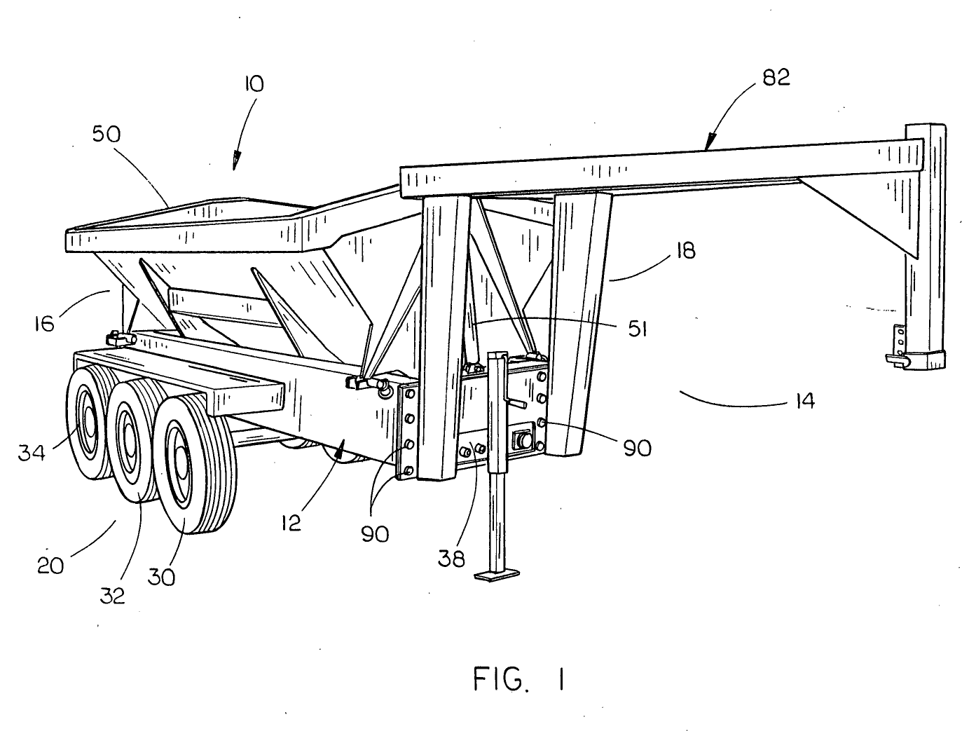

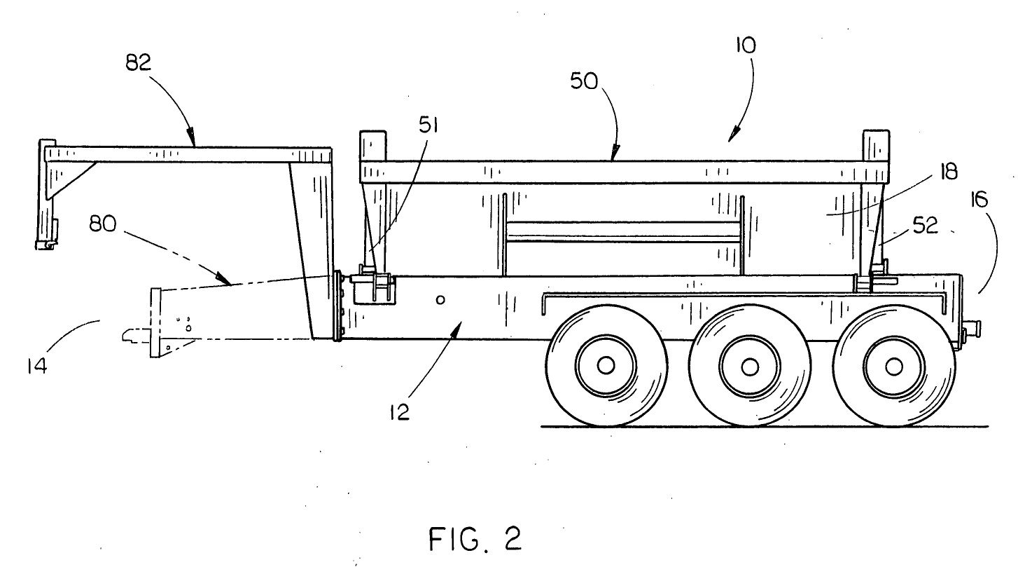

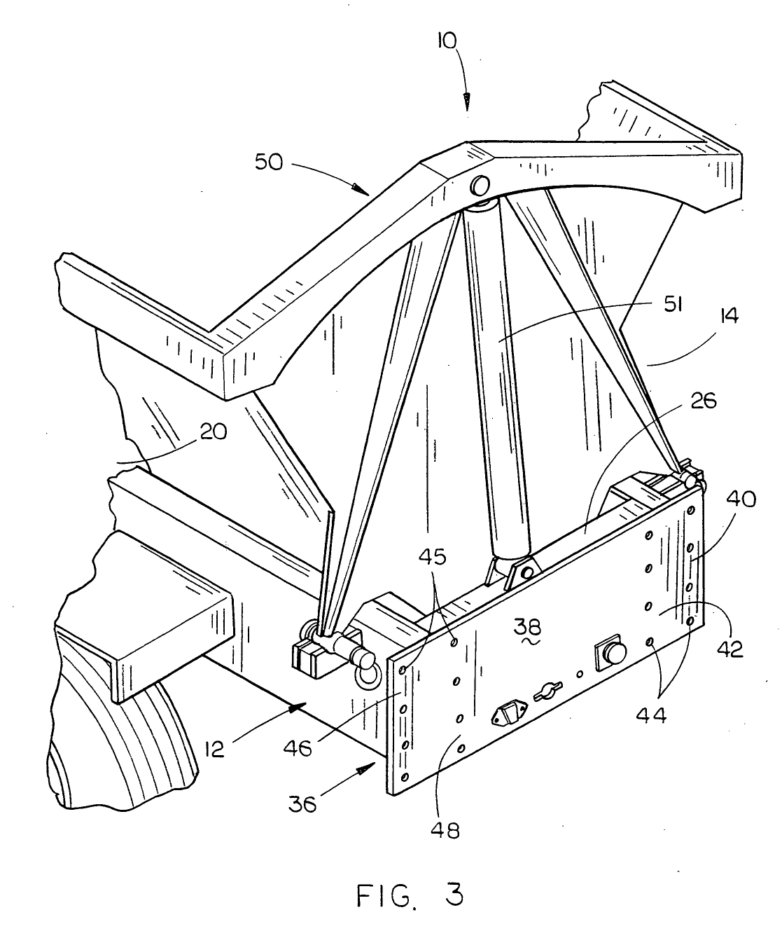

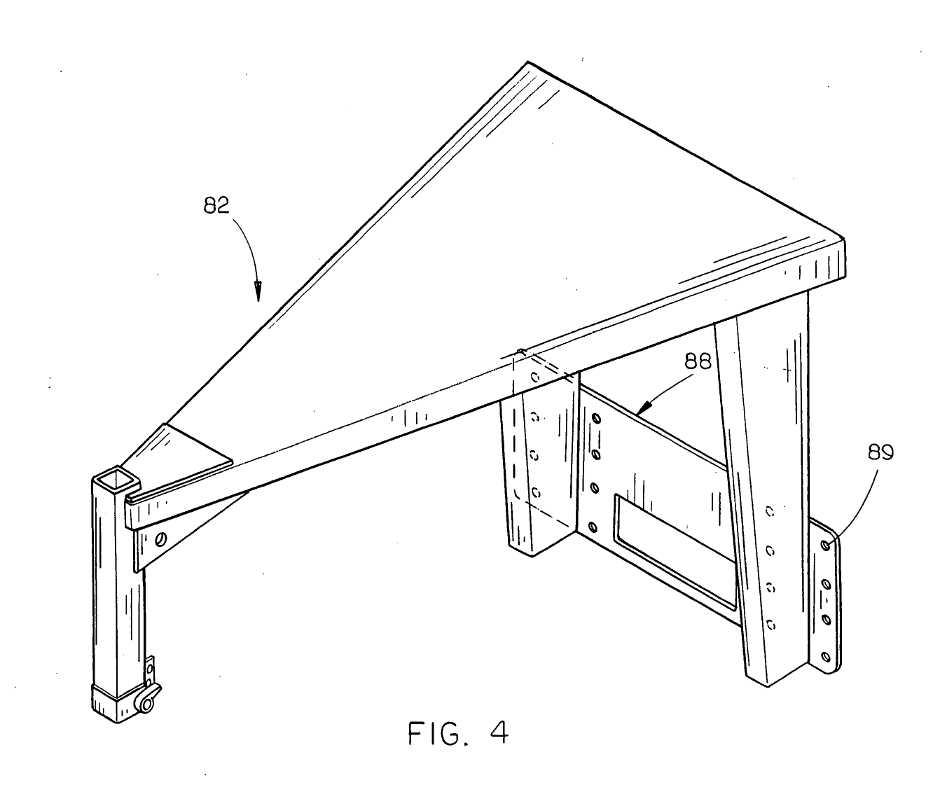

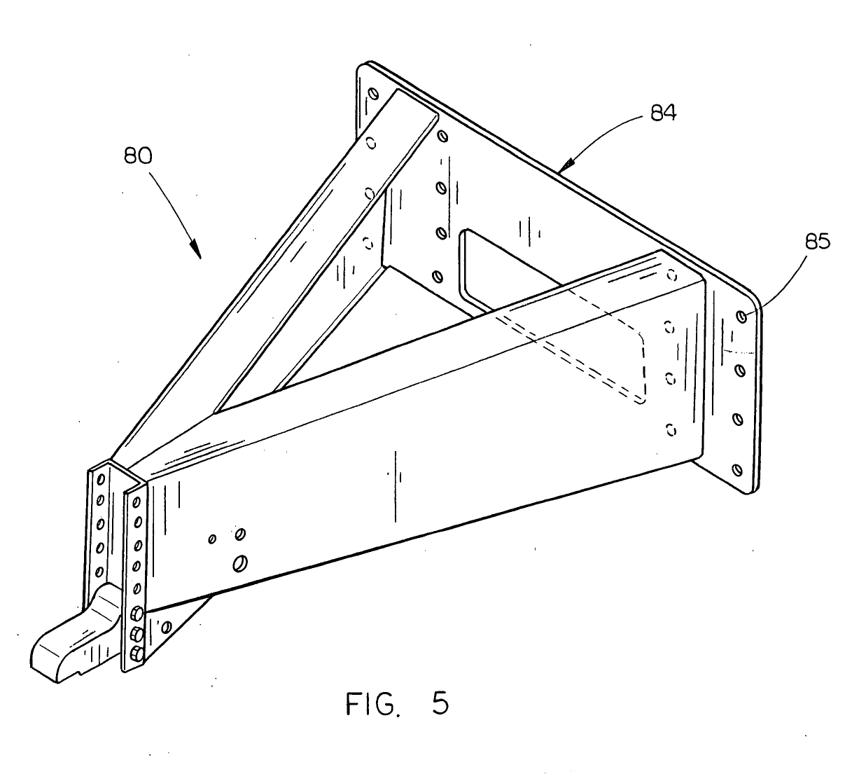

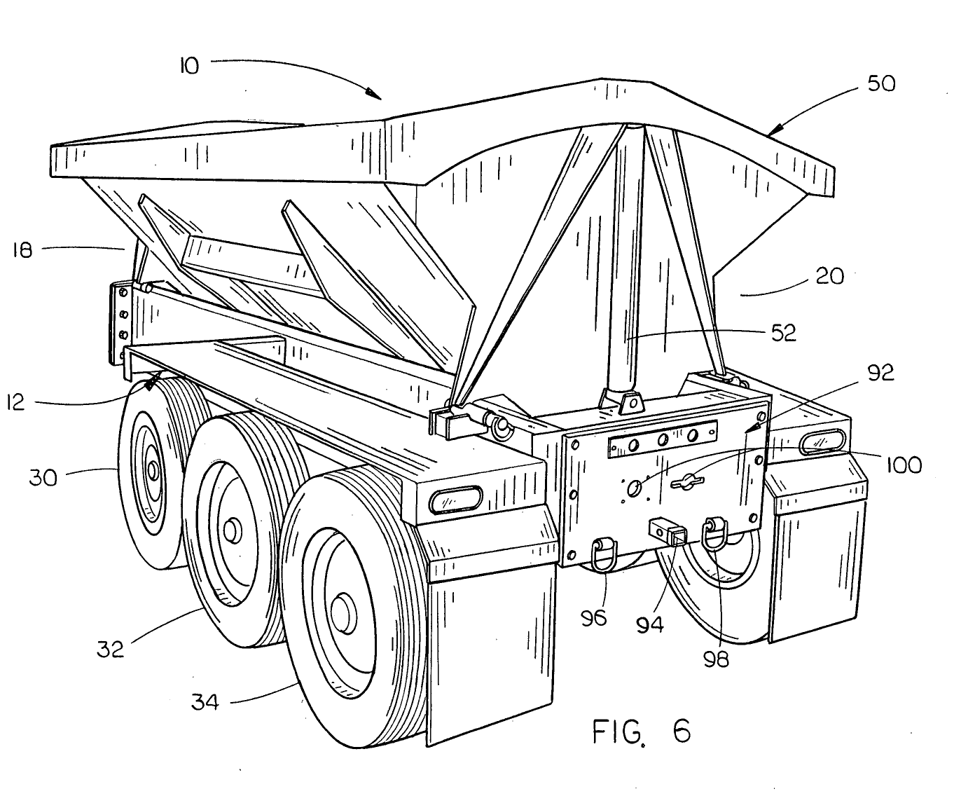

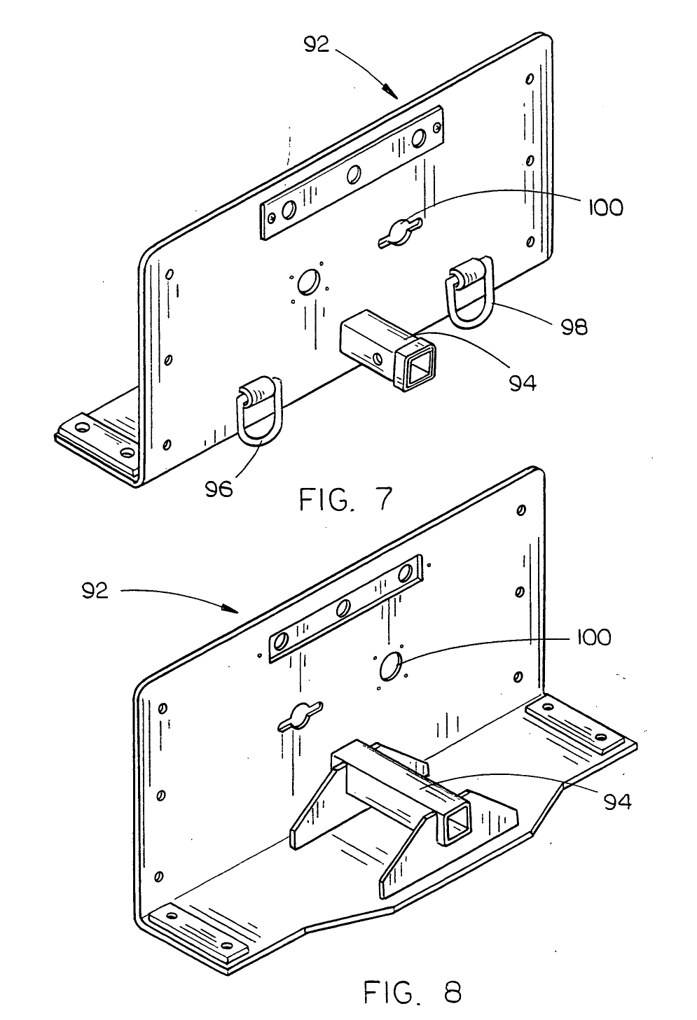

### DESCRIPTION OF THE PREFERRED EMBODIMENT

Embodiments are described more fully below with reference to the accompanying figures, which form a part hereof and show, by way of illustration, specific exemplary embodiments. These embodiments are disclosed in sufficient detail to enable those skilled in the art to practice the invention. However, embodiments may be implemented in many different forms and should not be construed as being limited to the embodiments set forth herein. The following detailed description is, therefore, not to be taken in a limiting sense in that the scope of the present invention is defined only by the appended claims.

The numeral 10 refers to the mid-sized side dump trailer of this invention which includes a wheeled frame 12 having a forward end 14, a rearward end 16, a first side 18, and a second side 20. Frame 12 includes longitudinally extending frame members 22 and 24 which have a rear frame member 26 secured to the rearward ends thereof and which extends therebetween. A front frame member 28 is secured to and extends between the forward ends of frame members 22 and 24. Preferably, three transversely extending axle and wheel assemblies 30, 32 and 34 are secured to the frame members 22 and 24 but a single or double axle and wheel assembly may also be utilized.

The numeral 36 refers to a hitch mounting structure and which includes a substantially vertically disposed mounting plate 38 which is welded to front frame member 28. Two rows 40 and 42 of bolt openings 44 are formed in mounting plate 38 at one side thereof and two rows 46 and 48 of bolt openings 45 are formed in mounting plate 38 at the other side thereof.

A side dump body 50 is pivotally mounted on the frame 12 such as disclosed in the co-pending application and is pivotally movable between a transport position and at least one side dumping position by at least one, and preferably two hydraulic cylinders 51 and 52. The numeral 54 refers to a 12-volt DC motor which drives a hydraulic pump 56 which is fluidly connected to a reservoir 58 by hose or line 60. Motor 54 is powered by a rechargeable battery 62 connected to a battery recharge unit 64 of conventional design.

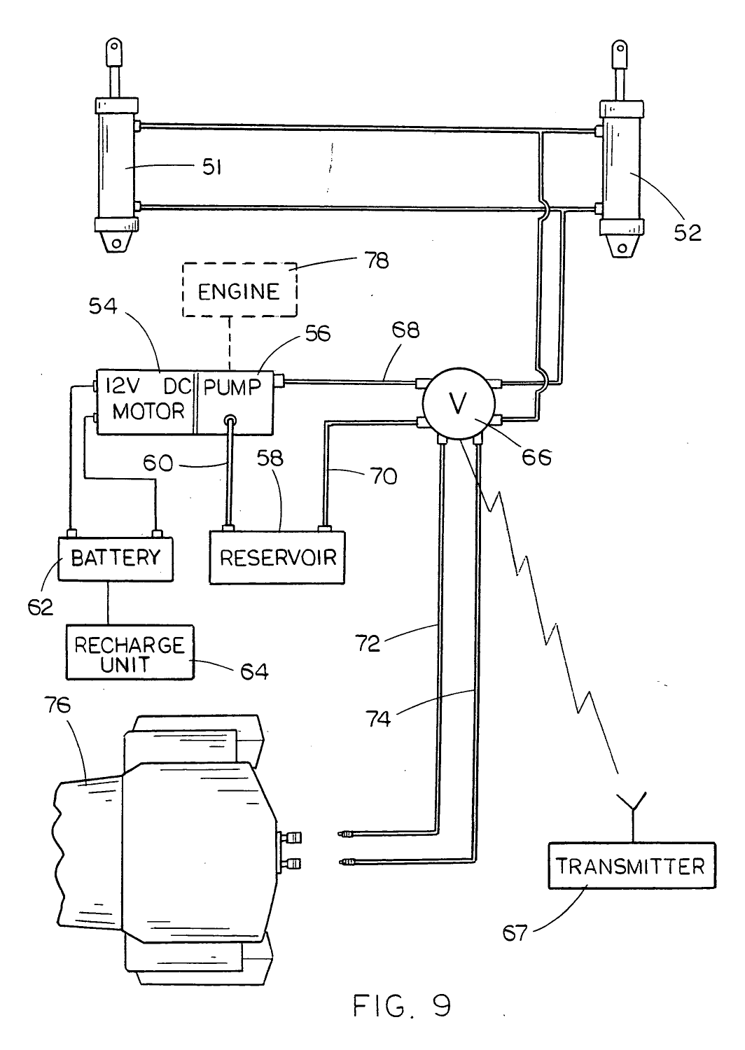

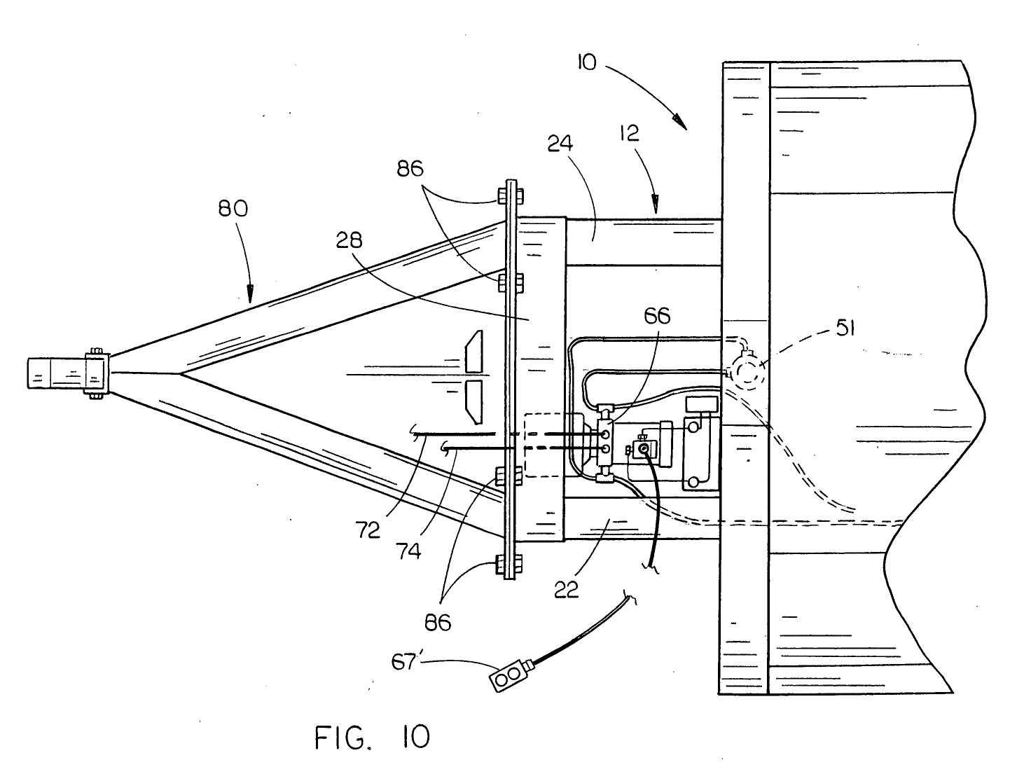

The numeral 66 refers to a valve, which is preferably radio controlled by transmitter 67 or remote control 67. The output side of pump 56 is connected to the inlet side of valve 66 by hose or line 68. Return line or hose 70 connects valve 66 to reservoir 58. Valve 66 is fluidly connected to cylinders 51 and 52 as seen in FIG. 9. Valve 66 has hoses or lines 72 and 74 extending therefrom which may be connected to the hydraulic pump system of a vehicle 76 if the puling vehicle 76 has a hydraulic pump system. Pump 56 may also be powered by a small internal combustion engine 78 if so desired.

The numeral 80 refers to a ball hitch assembly while the numeral 82 refers to a gooseneck hitch assembly, each of which may be selectively secured to the mounting plate 38. Ball hitch assembly 80 includes a mounting plate 84 at the rearward end thereof which has four rows of bolt openings 85 formed therein which are and adapted to register with the four rows 40, 42, 46 and 48 of bolt openings 44 in mounting plate 38. Bolts 86 extend therethrough the registering bolt openings in plates 38 and 84 to selectively secure ball hitch assembly 80 to the forward end of the frame 12.

The gooseneck hitch assembly 82 is provided with a mounting plate 88 which may be selectively secured to the mounting plate 38. The mounting plate 88 has four rows of bolt openings 89 formed therein which are adapted to register with the four rows 40, 42, 46 and 48 of bolt openings 44 in mounting plate. Bolts 90 extend through the registering bolt openings in plates 38 and 88 to selectively secure gooseneck hitch assembly 82 to the frame 12.

The interchangeability of the ball hitch assembly 80 with the gooseneck hitch assembly 82 enables the trailer to be used with a vehicle having a ball hitch structure or a gooseneck hitch structure associated therewith. The hydraulic cylinders 51 and 52 of this invention may be manually controlled by the valve 66 or remotely controlled by the transmitter 67 as illustrated in FIG. 9. The hydraulic pump 56 may be either powered by the 12-volt DC motor 54 or the engine 78. Further, the pump 56 may be eliminated if the vehicle 76 has a hydraulic pump system. The electrical system of the vehicle 76 may also be used to power the motor 54 if so desired. The rechargeable battery 62 enables the mid-sized trailer to be conveniently used without the necessity of connecting the pump 56 to either the vehicle hydraulic system or to the electric system of the vehicle 76.

The numeral 92 refers to a hitch structure which is bolted or otherwise secured to the rear of the frame members 14 and 16. Hitch structure 92 includes a receiver 94, chain connectors 96 and 98 as well as various openings 100 formed therein to permit electrical wires, hoses, etc. to be extended therethrough for connection to the trailer connected to the hitch structure 92.

The mid-size of the side dump body, which has a capacity of approximately midway between the mini-sized side dump body of the co-pending application and the conventional side dump bodies of the prior art. The fact that the trailer has a rear hitch assembly 92 provided thereon enables the contractor or the like to pull a skid steer loader trailer or the like behind the side dump trailer 10, thereby eliminating the need for the skid steer loader to be separately pulled to the job location. Therefore, it can be seen that the invention accomplishes at least all of its stated objected.

Although the invention has been described in language that is specific to certain structures and methodological steps, it is to be understood that the invention defined in the appended claims is not necessarily limited to the specific structures and/or steps described. Rather, the specific aspects and steps are described as forms of implementing the claimed invention. Since many embodiments of the invention can be practiced without departing from the spirit and scope of the invention, the invention resides in the claims hereinafter appended.

1. A side dump trailer, comprising:
a wheeled frame means having a forward end, a rearward end, a first side and a second side;
a side dump body pivotally mounted on said wheeled frame means and having a forward end, a rearward end, a first side and a second side;
said side dump body being pivotally movable on said wheeled frame means from a transport position to at least one side dumping position;
said wheeled frame means having a hitch mounting structure at its forward end to which a ball hitch assembly may be selectively secured thereto so as to extend forwardly from said forward end of said wheeled frame means or to which a gooseneck hitch assembly may be selectively secured thereto so as to extend upwardly and forwardly from said forward end of said wheeled frame means.

2. The side dump trailer of claim 1 wherein the ball hitch assembly or the gooseneck hitch assembly are bolted to said hitch mounting structure.

3. The side dump trailer of claim 2 wherein said hitch mounting structure includes a substantially vertically disposed first mounting plate with bolt openings formed therein and wherein the ball hitch assembly and the gooseneck hitch assembly each have a substantially vertically disposed second mounting plate with bolt openings formed therein so that either of the second mounting plates may be bolted to the first mounting plate.

4. The side dump trailer of claim 1 wherein said rearward end of said wheeled frame means also has a hitch provided thereon so that a trailer may be hitched to the rearward end of said wheeled frame means.

5. The side dump trailer of claim 1 wherein said side dump body is pivotally movable by at least one hydraulic cylinder and wherein a rechargeable battery is mounted on said wheeled frame means which drives an electrically operated hydraulic pump fluidly connected to at least one hydraulic cylinder.

6. The side dump trailer of claim 5 wherein said hydraulic pump is remotely radio controlled.

7. The side dump trailer of claim 1 wherein a power means is mounted on said wheeled frame which pivotally moves said side dump body between its transport and side dumping position.

8. The side dump trailer of claim 7 wherein said power means includes an electrically driven hydraulic pump which is fluidly connected to at least one hydraulic cylinder which pivots said side dump body.

9. The side dump trailer of claim 7 wherein said power means includes an engine driven hydraulic pump which is fluidly connected to at least one hydraulic cylinder which pivots said side dump body.

10. The side dump trailer of claim 8 wherein said hydraulic pump is connected to a rechargeable battery mounted on said wheeled frame means.
